(19) United States
(12) Patent Application Publication
(10) Pub. No.: US 2009/0043635 A1
(43) Pub. Date: Feb. 12, 2009

(54) SCHEDULING CHART CREATION SYSTEM AND PROGRAM FOR THE SAME

(75) Inventor: Yosuke MORI, Tokyo (JP)

Correspondence Address: STAAS & HALSEY LLP, SUITE 700, 1201 NEW YORK AVENUE, N.W., WASHINGTON, DC, 20005, US

(73) Assignee: WINWORKS KABUSHIKI KAISHA, Tokyo (JP)

(21) Appl. No.: 12/182,574

(22) Filed: Jul. 30, 2008

(30) Foreign Application Priority Data
Aug. 6, 2007 (JP) 2007-203828

(51) Int. Cl. G06Q 10/00; G06N 5/02

(52) U.S. Cl. 705/9; 706/47

(57) ABSTRACT

A scheduling chart creation system which reasonably controls a plurality of constraint conditions and creates a scheduling chart that corresponds to various working patterns and terms of employments. The scheduling chart creation system comprises a hierarchy control section and an application selection section. The hierarchy control section controls various rule information which is the information on terms of employment of employees and forms a constraint conditions at the time of creating a scheduling chart. The application selection section selects the rule information which is applied to the creation of the scheduling chart from the rule information. The hierarchy control section has an organization-data hierarchy control section which hierarchically controls the information of organization to which an employee belong as the rule information, and a time-data hierarchy control section to hierarchically controls a working date and a working pattern of the employee.

### FIELD OF THE INVENTION

The present invention relates to a technology for automatically creating a work scheduling chart of a member of a group such as an employee of a firm.

### PRIOR ART OF THE INVENTION

In firms or companies, it is necessary to create a work scheduling chart of employees, temporary staffs, part-time staffs etc. (herein after called “employees”) in various situations. For example, in a case where employees work on a rotating basis, a work scheduling chart should be created by performing an optimization in which working days, working hours, day off etc. of each employee needs to be determined in response to an increase and decrease in the work volume, working regulations, private circumstances of each employee, etc. (herein after called “optimization”). To reduce the burden of creating such scheduling chart, a schedule-chart automatically-creating techniques has been proposed. For example, a work-scheduling chart creation system using a genetic-algorithm optimization is known (for example, Patent Document 1: Unexamined Japanese Patent JP 2004-310530A). Further, there is also known a working-scheduling chart creating system which calculates a business skill of each employee and a personnel (or manpower) distribution is carried out based on this calculated results (for example, Patent Document 2-Unexamined Japanese Patent JP H11-143850A).

However, tasks and work volume are different from section to section, division to division and area to area, even in the same company. And the work volume tends to vary by season, month and day of the week even in the same section or division. Therefore, working schedules and employment conditions etc. for employees working in different departments or divisions often differ according to these various business circumstances. In the above-mentioned Patent Document 1 and 2, the constraint conditions at the time of creating a scheduling chart will become diversified because of such various differences. Accordingly, the volume of data or mathematical formulas which are stored and controlled in the schedule creating system for applying the constraint condition will become large, and the processing and information control will become complicated and troublesome, being inconvenient.

### SUMMARY OF THE INVENTION

The present invention was made in consideration of the above-mentioned problems and an object of the present invention is to provide a work scheduling chart creation system in which constraint conditions used at the time of creating the scheduling chart can be reasonably controlled. Without imposing too much burden on a computer, the work scheduling chart of the present invention can be created in response to various working patterns and working conditions.

To solve the problems, a first aspect of the present invention is a work scheduling chart creation system for automatically creating a date and time scheduling chart for an employee of a company, which comprises:

hierarchical control means for controlling various rule information in the form of a hierarchical structure, the rule information being obtained from information on employment conditions of the employee and forming a constraint condition used at the time of creating the scheduling chart; and

an application selection means for selecting the rule information which is applied to the creating of the scheduling chart from the various rule information which is hierarchically controlled by the hierarchical control means.

A second aspect of the present invention is that in addition to the first aspect, the hierarchical control means comprising an organization-data hierarchical control means in which organization-related information of a department etc. to which the employee belongs is stored as the rule information and the organization-related information is hierarchically controlled.

A third aspect of the present invention is that in addition to the first aspect, the hierarchical control means comprises a working-time data hierarchical control means in which working pattern-related information including such as a working day, with or without shift, non-working day etc. of the employee is stored as the rule information and the working pattern-related information is hierarchically controlled.

A fourth aspect of the present invention is that in addition to the first aspect, the scheduling chart creation system has an integer programming solver which creates the scheduling chart through an integer programming using an objective function and a prescribed constraint condition, the application selection means selects the rule information having both the objective function capable to be applied to the integer programming solver and the prescribed constraint condition capable to be applied to the integer programming solver, and the integer programming solver creates the scheduling chart using the rule information selected by the application selection means.

A fifth aspect of the present invention is that in addition to the fourth aspect, the scheduling chart creation system has a rule-relaxation means, when the integer program solver can not create the scheduling chart using the rule information selected by the application selection means, the rule-relaxation means being designed to relax the rule information so that the scheduling chart can be created in the integer programming solver.

A sixth aspect of the present invention is a program for making a computer function as the scheduling chart creation system according to claim 1.

### EFFECTS OF THE INVENTION

According to the first aspect, the scheduling chart creation system has hierarchical control means for controlling various rule information in the form of a hierarchical structure, which is obtained from information on employment conditions of the employee and forms a constraint condition used at the time of creating the scheduling chart, and an application selection means for selecting the rule information which is applied to the creation of the scheduling chart from various rule information which is hierarchically controlled by the hierarchical control means. Accordingly, a group of information which are relevant to each other are gathered to form a group. The group of information can be controlled as one group and can be used for creating the scheduling chart. Therefore, a plurality of constraint conditions used at the time of creating a scheduling chart can be reasonably controlled and a scheduling chart corresponding to various working pattern and employment conditions can be created without imposing a great burden on a computer.

According to the second aspect, the hierarchical control means has an organization-data hierarchical control means in which organization-related information of a department etc. to which the employee belongs as the rule information and the organization-related information is hierarchically controlled. Accordingly, the group of rule information which are relevant to each other can be controlled hierarchically like a relationship between the departments or divisions in a company and can be used integratedly. Accordingly, the rule information which increases due to the type of work and work volume which also vary by department, division and location in a company can be reasonably controlled. And convenience in the usage of the rule information at the time of creating the scheduling chart can be improved.

According to the third aspect, the hierarchical control means has the working-pattern-related information such as a working day, with or without shift, non-working day etc. of an employee as the rule information and has a time-data hierarchical control means in which the working-pattern related information is hierarchically controlled. Accordingly, a group of rule information which are relevant to each other can hierarchically be controlled based on the time information which decides the type of work and work volume in the company, and can integratedly be utilized. Thus the rule information which increases in volume caused by the difference in the tasks and work volume due to a seasonal, monthly and day-of-the-week fluctuation etc., can reasonably be controlled. And convenience in the usage of the rule information at the time of creating a scheduling chart can be improved.

According to the fourth aspect, the scheduling chart creation system has an integer programming solver which creates the scheduling chart through an integer programming using an objective function and a prescribed constraint condition, the application selection means selects the rule information having both the objective function capable to be applied to the integer programming solver and the prescribed constraint condition capable to be applied to the integer programming solver, and the integer programming solver creates the scheduling chart using the rule information selected by the application selection means. Therefore, the computer can be easily executed, and a scheduling chart having high adaptability to a condition of an organization or time etc. can be created. Accordingly, the scheduling chart created by the present invention can be rated high in terms of usefulness.

According to the fifth aspect, the scheduling chart creation system has a rule-relaxation means. When the integer programming solver can not create the scheduling chart using the rule information selected by the application selection means, the rule relaxation means is designed to relax the rule information so that the scheduling chart can be created in the integer programming solver.

Therefore, the scheduling chart creation system can avoid a situation in which the scheduling chart can not be created for the reason that the scheduling chart creation system is unable to relax an applicable condition of the rule information. According to this rule-relaxation means, the scheduling chart can be created much smoothly even under a situation where the number of employees available increases or decreases frequently.

According to the sixth aspect, a program for the scheduling chart creation system of the present invention can make various computer hardware functions as the scheduling chart creation system

### BRIEF DESCRIPTION OF THE DRAWINGS

FIG. 1 is a system block and functional block diagram showing the scheduling chart creation system of a first embodiment of the present invention.

FIG. 2 is a functional block diagram showing the scheduling chart creation system of FIG. 1.

FIG. 3A is a schematic diagram showing a data structure which is used in the scheduling chart creation system of FIG. 1,

FIG. 3B is a schematic diagram showing an array for specifying the shift variations of a specific employee on the specific day in the data used in the scheduling chart creation system 1 of FIG. 1.

FIG. 4 is a schematic diagram showing the organization hierarchy which is defined at the scheduling chart creation system of FIG. 1.

FIG. 5 is a schematic diagram showing an organization hierarchy definition table which is controlled at an organization-data hierarchical-control section of the scheduling chart creation system of FIG. 1.

FIG. 6 is a schematic diagram showing a rule table which is controlled at the organization-data hierarchical-control section of the scheduling chart creation system of FIG. 1.

FIG. 7 is a flowchart showing an extraction processing for extracting a rule information which is applied to a specific node of a specific hierarchy using a table controlled at the organization-data hierarchical-control section of the scheduling chart creation system of FIG. 1.

FIG. 8 is a schematic diagram showing a time hierarchy etc. which is defined at the scheduling chart creation system of FIG. 1.

FIG. 9 is a schematic diagram showing the time hierarchy definition table which is controlled at the time-data hierarchical-control section of the scheduling chart creation system of FIG. 1.

FIG. 10 is a flowchart showing an extraction processing for extracting a rule information which is applied to a specific time using tables controlled at the time-data hierarchical-control section of the scheduling chart creation system of FIG. 1,

FIG. 11 is a functional block diagram showing a scheduling chart creation system of a second embodiment of the present invention.

FIG. 12 is a flowchart showing a relaxation procedure of a rule information at the scheduling chart creation system of FIG. 11.

### PREFERRED EMBODIMENT OF THE PRESENT INVENTION

### First Embodiment

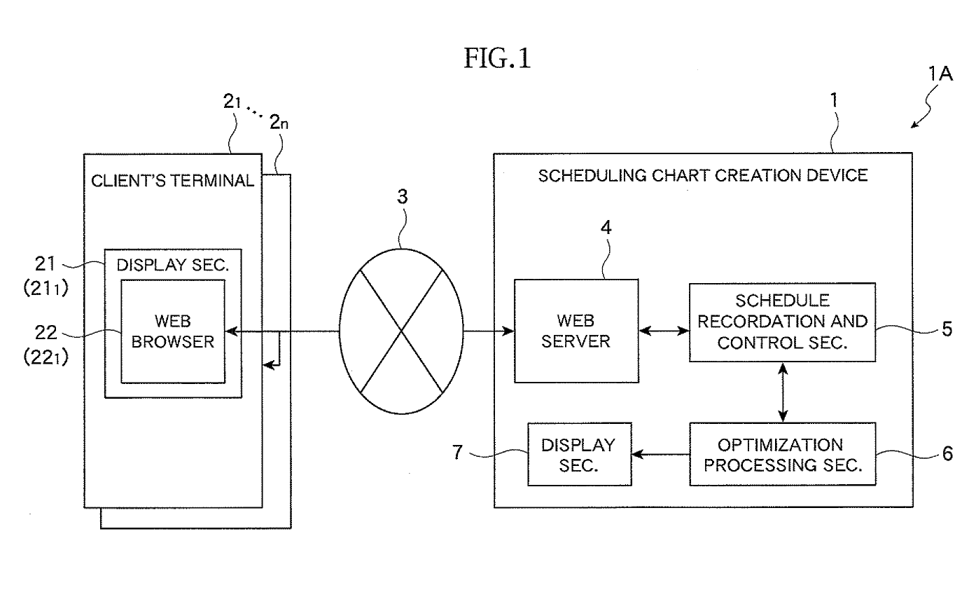

The first embodiment of the present invention is shown in FIGS. 1 to 10.

FIG. 1 is a system block diagram and a functional block diagram showing the scheduling chart creation system of the first embodiment. As shown in FIG. 1, a scheduling chart creation system 1A is a client server system comprising a scheduling chart creation system 1 and n (n≧1) units of client terminal 2₁-2ₙ. The scheduling chart creation system 1 and the client terminals 2₁-2ₙ are designed to communicate with each other through Internet 3 as WAN (Wide Area Network). In this embodiment, “scheduling chart” means a work schedule of an employee, but not limited to this. The system of the scheduling chart creation system of this embodiment can be applied to any systems which automatically create charts which are used for scheduling management.

The scheduling chart creation system 1 is a computer system which is controlled by a business organizer who records and manages, by request from other organizations having a plurality of members, schedule information of each member of the other organizations. In this embodiment, the organization is a business enterprise having employees who work on a rotation basis. However employees may be members working on a non-rotating basis. Further, the organization may be a family, school, various non-profit organizations etc.

The scheduling chart creation system 1 comprises a web server 4, a schedule recordation and control section 5, optimization processing section 6 and display section 7. The Web server 4 serves as a data communicator communicating with the client terminals 2₁-2ₙ. The schedule recordation-and-control section 5 has a role to record and centrally control the schedule information. The schedule recordation-and-control section 5 forms a repository system on which various information including schedules of employees or a specific individual in each community are recorded. The optimization processing section 6 performs matching of various information (for example, employment conditions of the organization, terms desired by a job seeker etc.) recorded on the schedule recordation and control section 5, optimizing various information for matching and creating an optimized schedule of each employee. The display section 7 is comprised of an LCD (Liquid Crystal Display) etc. and displays various instructions and images input from an operation section such as a mouse or a keyboard etc. (not shown).

The client's terminals 2₁, . . . , 2ₙ correspond to communication terminals such as personal computers, cell-phone units, electronic notebooks, PDAs (Personal Digital Assistants) etc. which are used by the employees who work on a rotating basis at the organizations and each client terminal has a data communication function. Each of the client's terminals 2₁, . . . , 2ₙ has an operation section (not shown) such as a mouse, a keyboard etc. which is used for inputting various instructions and has a display section 21₁, . . . , 21ₙ (not shown) each of which has the same structure (configuration) as that of the display section 7, on which the Web browser 22₁, . . . , 22ₙ (not shown) is displayed. Here each client terminal 21₁, . . . , 21ₙ, display section 21₁, . . . , 21ₙ and Web browser 22₁, . . . , 22ₙ have the same structure so that these are herein after each called as a client terminal 2, a display section 21, and a Web browser 22 except when there is a necessity to distinguish each of them from the other.

As not shown in FIG. 1, the Webserver 4 and the schedule recordation-and-control section 5 of the scheduling chart creation system 1 have at least one CPU (Central Processing Unit), RAM (Random Access Memory) functioning as a working area for CPU, ROM (Read Only Memory) on which a boot program is recorded, an auxiliary storage system such as hard disk etc. on which various programs and data etc. are stored and a communication interface used for sending and receiving data. Programs for OS (Operating System), various application programs and data are stored on the auxiliary storage unit. These programs and data are arithmetically processed in cooperation with the hardware resources to realize various functions.

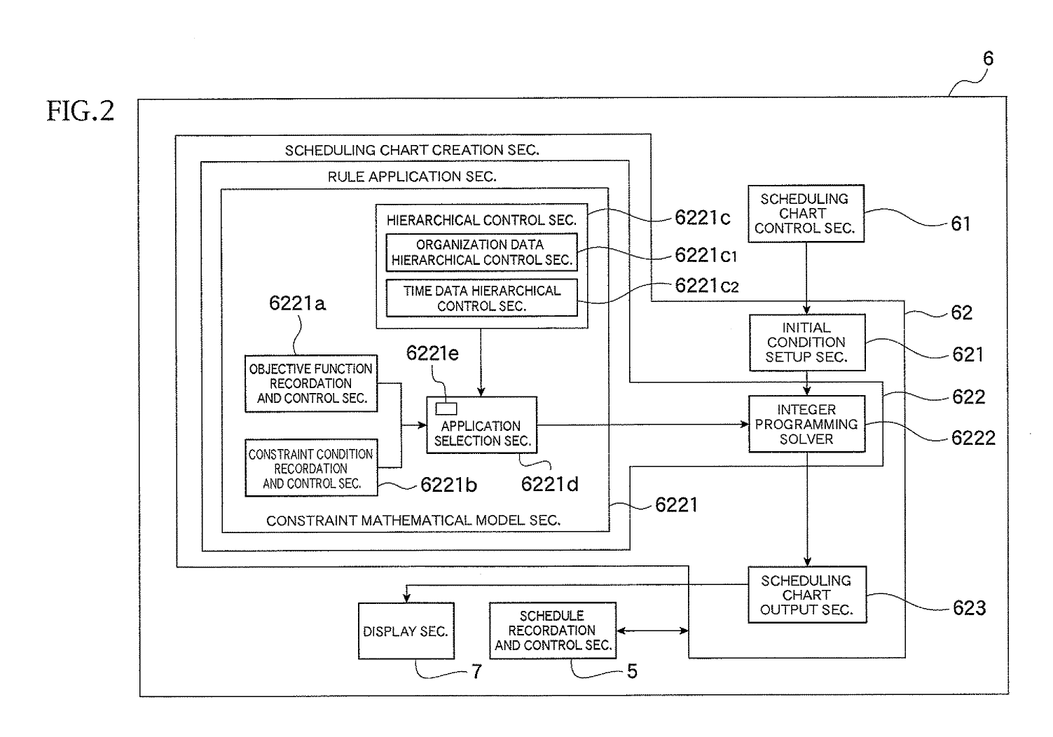

FIG. 2 is a functional block diagram of the scheduling chart creation system 1. As shown in FIG. 2, the optimization processing section 6 of the scheduling chart creation system 1 has a scheduling chart control section 61 and a scheduling chart creation section 62 as a functional means.

The scheduling chart control section 61 performs recordation and control of a fixed schedule information of each employee such as a scheduled day of a business trip, a scheduled day of a paid leave etc. The scheduling chart creation section 62 creates a scheduling chart after the schedule is optimized based on a given condition.

The scheduling chart creation section 62 has an initial-condition setup section 621, a rule-application section 622 and a scheduling chart output section 623. The initial condition (herein after called in short “initial condition”) setup section 621 obtains information of an initial condition which is a content of a scheduling chart to be created and information which is used for creating the scheduling chart, and performs a necessary processing for creating the scheduling chart. The rule application section 622 creates a scheduling chart optimized by applying a rule information which forms a constraint condition at the time of creating the scheduling chart. The scheduling chart output section 623 outputs the created scheduling chart on the display section 7.

The rule application section 622 further has: a constraint mathematical model section 6221 which controls the objective function and a prescribed constraint condition; and an integer programming solver 6222 which creates a scheduling chart through the integer programming using the objective function and the prescribed constraint conditions.

The constraint mathematical model section 6221 further has an objective-function recordation-and-control section 6221a, a constraint-condition recordation-and-control section 6221b, a hierarchical control section 6221c as a “hierarchical control means” and an application selection section 6221d as an “application selection means”. On the objective-function recordation-and-control section 6221a and the constraint-condition recordation-and-control section 6221b, the objective function and constraint condition to be used in the integer programming are recorded. On the hierarchical control section 6221c, various rule information is recorded as a hierarchically structured data. The rule information is an information related to the employment condition of the employee and forms the constraint conditions at the time of creating the scheduling chart (herein after called in short “rule information”). The application selection section 6221d selects a rule information which is applied for creating the scheduling chart, from the rule information hierarchically controlled at the hierarchical control section 6221c. The application selection section 6221d also obtains the objective function and the constraint condition, which are used for the rule information, from the objective-function recordation-and-control section 6221a and the constraint-condition recordation-and-control section 6221b, and then applies to the rule information. A temporally storage region is provided at the application selection section 6221d. At this temporally storage region, a date list 6221e is formed (described later in detail).

The hierarchical control section 6221c further has an organization-data hierarchical-control section 6221c1 and a time-data hierarchical-control section 6221c2. The organization-data hierarchical-control section 6221c1 has an organization-related information of a department to which the employee belongs as a rule information and hierarchically controls this organization-related information (details will be described later). The time-data hierarchical-control section 6221c2 has a working-pattern-related information relating to such as a working day, with and without shift, non-working day etc. as rule information and hierarchically manages this working-pattern-related information (details will be described later).

Next, a data structure used for creating the scheduling chart in the scheduling chart creation system 1 will be explained.

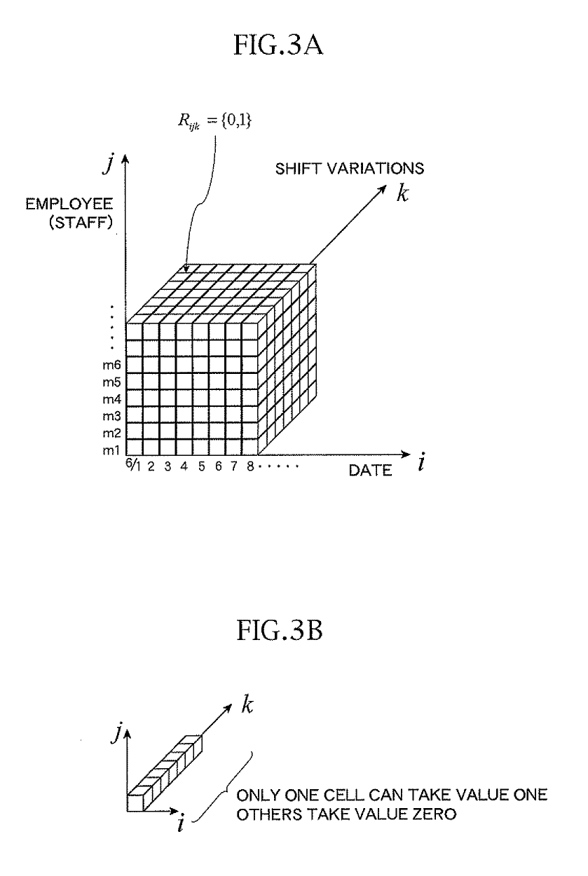

FIG. 3A schematically shows the data structure used in the scheduling chart creation system 1 of this embodiment. The data of the data structure shown in FIG. 3A are stored in the schedule recordation-and-control section 5 as data showing each scheduling chart. FIG. 3A is utilized for a scheduling chart having a working pattern including a plurality of shifts such as a morning, afternoon or night shift. More specifically, the scheduling chart has a data structure that can represent as a three-dimensional [3D] array as shown in FIG. 3A.

The i-axis, j-axis and k-axis each shows day, employee (staff) and type of shift (explained later). Each block shows a specific shift of a specific employee on a specific day recorded on the scheduling chart. Each cell is expressed by the following equation.

### Equation (1)

Rᵢⱼₖ={0,1} (1)

wherein R is a variable and assigned to 0 or 1. That is, every data (every cell in FIG. 3A) in the scheduling chart shows a binary data of 0 or 1.

FIG. 3B is a schematic diagram showing an array for specifying the type of shift of a specific employee on the specific day in the data used in the scheduling chart creation system 1. In FIG. 3B, one cell in the array in the k-axis direction can be assigned to value one and others are set to value zero. That is, a specific employee can be assigned to only one type of shift on a specific day.

Next, in the scheduling chart creation system 1 of this embodiment, the objective function and the constraint condition used for creating the scheduling chart will be explained.

In the objective function recordation-and-control section 6221a and the constraint mathematical model section 6221 in FIG. 2, many of the objective functions for optimizing the above mentioned scheduling chart and the constraint-conditions for constraining the objective functions are recorded.

For example, in a case where more than 10 employees should be scheduled to work on a specific day (for example June 15^{th}), the following objective function (2) and constraint condition (3) are used.

$$\begin{matrix}Equation ( 2 ) & \\ {\sum }_{j = 1}^{jx} {\sum }_{k = 1}^{kx} ( {R}_{10 jk} \times {S}_{k} ) \geq 10 & ( 2 )\end{matrix}$$

wherein
R is a variable and assigned to 0 or 1,
jx: maximum value of j
kx: maximum value of k
S: vector data representing a type of shift

### Equation (3)

Sₖ={0,1} (3)

wherein
S: vector data representing a type of shift
l: shift which is qualified as work
0: shift which is not qualified as work
   Further, when performing optimization to maximally reduce the man-day as a whole, following objective function (4) is used.

$$\begin{matrix}Equation ( 4 ) & \\ minimizeN \\ N = {\sum }_{i = 1}^{ix} {\sum }_{j = 1}^{jx} {\sum }_{k = 1}^{kx} ( {R}_{ijk} \times {S}_{k} ) & ( 4 )\end{matrix}$$

wherein
N: total man-day
ix: maximum value of i
jx: maximum value of j
kx: maximum value of k
R: variable and is assigned to 0 or 1
S: vector data representing a type of shift
   Furthermore, when the number of employees who are scheduled to work is set to be the same every day, a plurality of objective functions can be combined together as represented by an equation (5).

$$\begin{matrix}Equation ( 5 ) & \\ minimizeN \\ N = {a}_{1} \times {N}_{1} + {a}_{2} \times {N}_{2} \\ {N}_{1} = {\sum }_{i = 1}^{ix} {\sum }_{j = 1}^{jx} {\sum }_{k = 1}^{kx} ( {R}_{ijk} \times {S}_{k} ) \\ {n}_{i} = {\sum }_{j = 1}^{jx} {\sum }_{k = 1}^{kx} ( {R}_{ijk} \times {S}_{k} ) \\ {N}_{2} = max \{ {n}_{1} , {n}_{2} , {n}_{3} … {n}_{ix} \} & ( 5 )\end{matrix}$$

wherein
N: the entire number of working employees
a₁, a₂: weighting factor
R: variable and assigned to 0 or 1
ix: maximum value of i
jx: maximum value of j
kx: maximum value of k
S: vector data representing a type of shift

In this embodiment, the objective function and constraint condition represented by the above mentioned equations (1) to (5) are used together with a hierarchy which will be described later.

Next, a concrete structure of information which is controlled in the organization-data hierarchical-control section 6221c1 and a concrete procedure of application of the rule information will be explained.

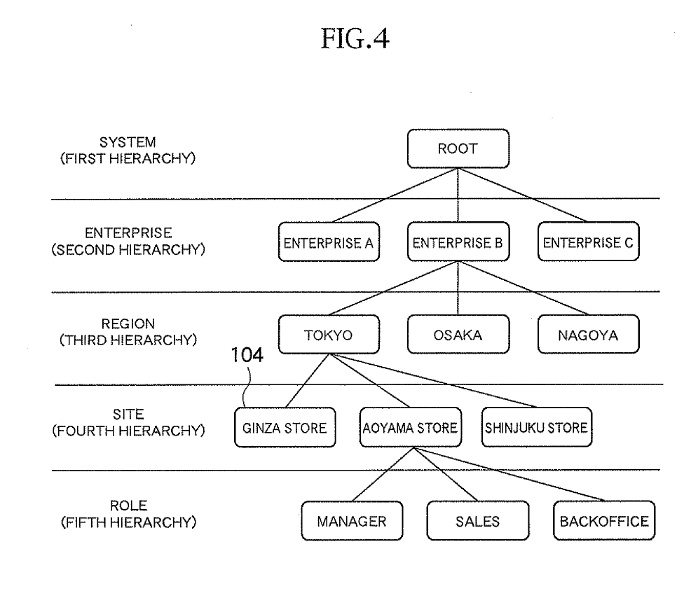

FIG. 4 schematically shows the organization hierarchy etc. as defined in the scheduling chart creation system 1 of this embodiment. As shown in FIG. 4, in the scheduling chart control system 1A, a plurality of organization hierarchy (the number of hierarchy is five)—a system hierarchy (a first hierarchy), an enterprise hierarchy (a second hierarchy), a region hierarchy (a third hierarchy), a site hierarchy (a fourth hierarchy) and a role hierarchy (a fifth hierarchy) is defined and arranged from top to bottom in this order. Nodes are defined for each hierarchy. Each hierarchy is classified based on a hierarchical relationship in terms of the name of the enterprise or a hierarchical relationship of a specific company (relationship in terms of dependency or dominancy etc) More specifically, node which defines division, department, position of the employee etc. is provided. At the system hierarchy, the node called “ROOT” which represents the system itself is provided. At the enterprise hierarchy, the node represents the enterprise itself such as “enterprise A”, “enterprise B”. At the region hierarchy, the node represents an area in which a division or business office is established such as “Tokyo”, “Osaka” etc. At the site hierarchy, the node represents a store location such as “Ginza”, “Aoyama” etc., in which a division or a business office is located. At the role hierarchy, the node represents a position of an employee such as “manager”, “sales” etc. These nodes form a tree structure starting from a node of “ROOT”.

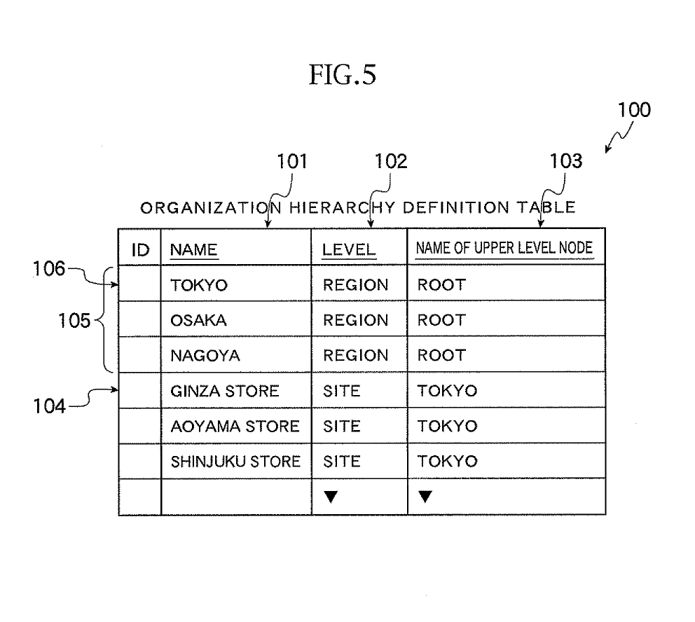

FIG. 5 is a schematic diagram showing an organization hierarchy definition table which is controlled by the organization-data hierarchical-control section 6221c1 of the scheduling chart creation system of this embodiment. The organization hierarchy definition table 100 is a table formed from the organization hierarchy shown in FIG. 4. Each node and relationship between nodes are defined by a name column 101, hierarchical level column 102 and a name column of an upper node 103. Each line represents one node. For example, 104 in line 4 is the “Ginza store” node at the site hierarchy and the upper node thereof is the “Tokyo” node (FIG. 4). In addition, in the hierarchy definition table 105, the names of the upper node in the lines 1 to 3 are not named as “enterprise” which is an immediate upper node but are named as “ROOT”. This is because “enterprise A”, “enterprise B” etc. in the enterprise hierarchy directly define their lower hierarchy so that the node in the top hierarchy is defined as an upper node.

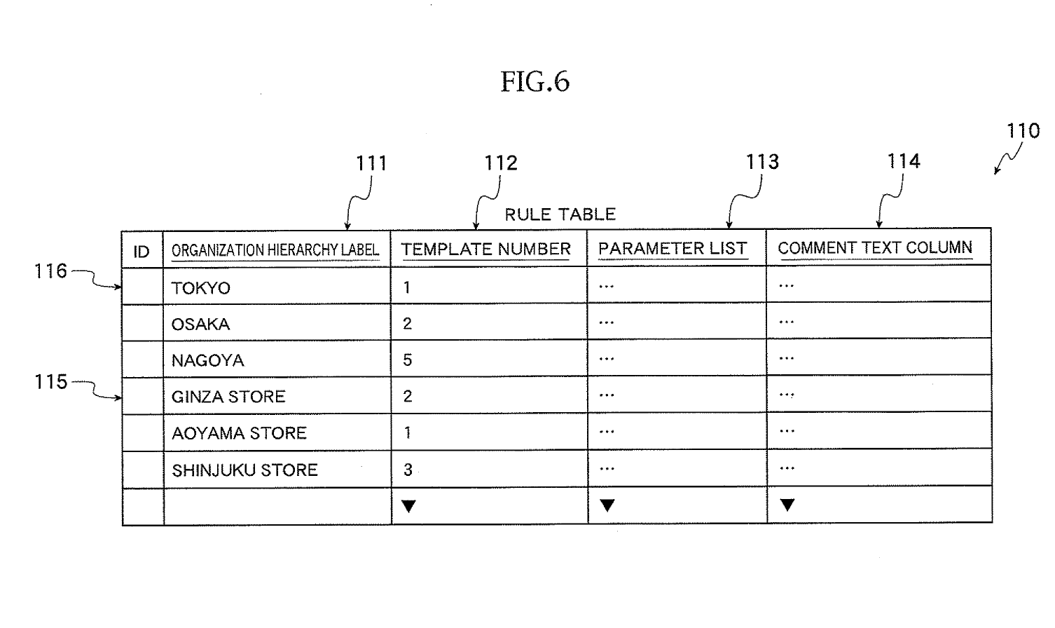

FIG. 6 is a schematic diagram showing a rule table which is controlled at the organization-data hierarchical-control section 6221c1 of the scheduling chart creation system of this embodiment. This rule table 110 defines a rule of every node of the organization hierarchy based on a organization hierarchy label column 111, a template number column 112, a parameter list column 113 and a comment text column 114, and each line forms the rule information defined by one node itself. In each line, a name of a node by which a rule information of each line is defined in the organization hierarchy label column 111. An equation for objective function and constraint condition applied to the rule information in each line (which is an equation shown, for example, by the equations (1) to (5), in this embodiment serial number is attached to each equation. This serial number corresponds to the template number) is defined in the template number column 112. In the parameter list column 113, a parameter value to be delivered to the variable of the equation specified by the template number column 112 is defined. In the comment text column 114, information for roughly explaining the meaning of the rule information in each line is defined.

Next, a procedure for extracting a rule using these tables will be explained.

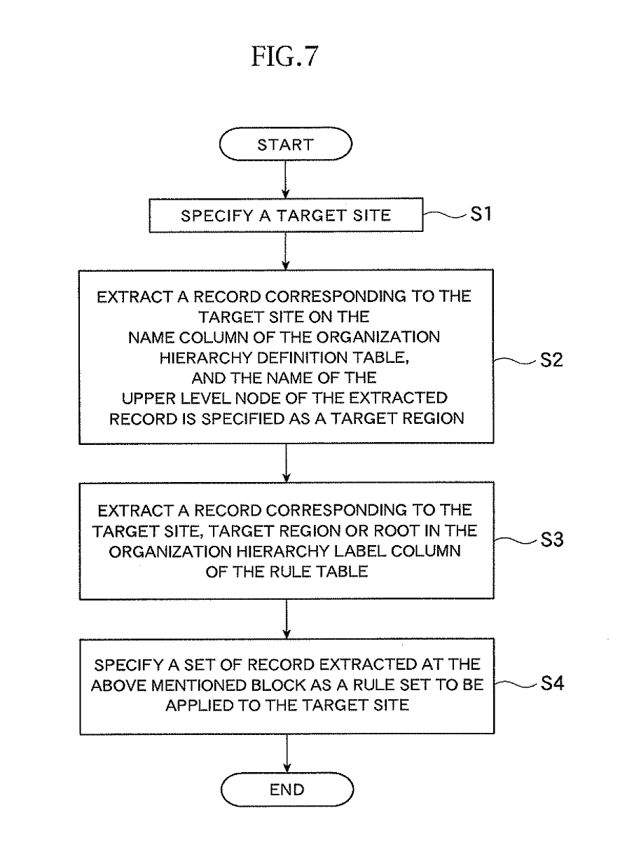

FIG. 7 is a flowchart showing a processing to extract a rule information, which is applied to a specific node of a specific hierarchy, using each table which is controlled in the organization-data hierarchical control section 6221c1 of the scheduling chart creation system 1 of the present embodiment. The processing is performed at the application selection section 6221d. The flowchart is typically explained by showing the processing of the node of the site hierarchy, but the processing of a node of a hierarchy other than the site hierarchy can be carried out by the same procedure written in this flowchart. For example, when a rule information defining a rule which is applied to the node 104 of the “Ginza store” of the site hierarchy shown in FIG. 4 is treated, the application selection section 6221d at first extracts a target site hierarchy (Step S1). Then, the node 104 of the “Ginza store” in the organization hierarchy definition table 100 is extracted (Step S1). A line (record) 104 including the target “Ginza store” in the name column 101 of the organization hierarchy definition table 100 is extracted. Then the name “Tokyo” as a target region, which exists both in the line 104 in which the “Ginza store” exists and in the upper level node name column 103 is selected. And then the line including “Tokyo” in the name column 101 of the organization hierarchy definition table 100 is selected. Next, the “ROOT” which exists both in the line 106 and in the upper level node name column 103 of the organization hierarchy definition table 100 (Step 2) is extracted. In other words, the step S2 performs extraction using the organization hierarchy definition table 100 in such a manner that the processing tracks back along the node from the hierarchy extracted at the step S to the top hierarchy (FIG. 4).

Next, the extraction selection section 6221d extracts a line (record) corresponding to a line which is extracted at step S2 from the rule table 110. In this embodiment, the line 115 which includes “Ginza store” in the organization hierarchy label column 111 and the line 116 which includes “Tokyo” in the organization hierarchy label column 111 are extracted from the rule table 110. The “Ginza store” and “Tokyo” corresponds to the target site and target region (root), respectively (Step S3).

The application selection section 6221d considers a set of lines (records) extracted at the Step S3 as a rule set (rule information) to be applied to a target site (Step S4). More specifically, the objective function or an equation of the constraint conditions which are defined by the number of the template number column 112 in the line (corresponding to the lines 115 and 116 of the rule table 110) extracted at step S3, and a value of parameter defined at the parameter list column 113 are regarded as a rule set (rule information) of the “Ginza store” node 104.

As mentioned above, the system has the organization-data hierarchical control section 6221c1 in which an organization-related information of a department etc. to which the employee belongs, is held as the rule information and the organization-related information is hierarchically controlled. Therefore, rule information which are highly relevant to each other can be controlled similarly like a relationship between departments or divisions in one enterprise and can be integrally utilized. As stated above, an increase in the rule information induced by the difference in the type of work and volume of work in every department, division and location can reasonably be controlled, and the convenience in handling the rule information at the time of creating the schedule information can be enhanced.

Next, an information structure and a procedure of applying the rule information in the time-data hierarchical control section 6221c2 of the scheduling chart creation system 1 of this embodiment, will be explained.

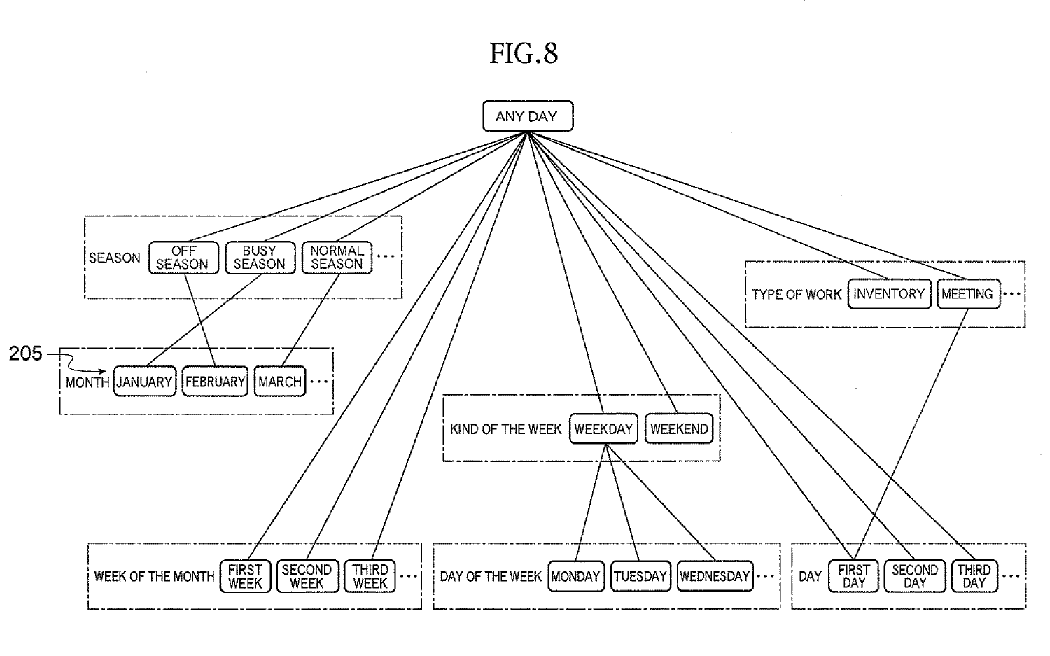

FIG. 8 is a schematic diagram showing a time hierarchy etc. which is defined in the scheduling chart creation system 1 of this embodiment.

As shown in FIG. 8, a multiple time hierarchies including season, month, day, week, kind of the day of the week, day of the week and type of work are defined in the scheduling chart control system 1A. A node which is included in a category of a hierarchy is defined in each hierarchy. The node of the season hierarchy and a month hierarchy and the node of kind of a day of the week hierarchy and the node of a day of the week hierarchy are in a hierarchical relationship. Accordingly, these hierarchies are formed into a hierarchical relationship. In addition, every node forms a tree structure having a starting point “Any date” node which does not belong to any hierarchy. The definition of the “kind of work hierarchy”, “Inventory” node and “Meeting” node in the “kind of work hierarchy” are not indispensable, but on the day when “Inventory” or “Meeting” is taken place or held, this “kind of work” node is defined.

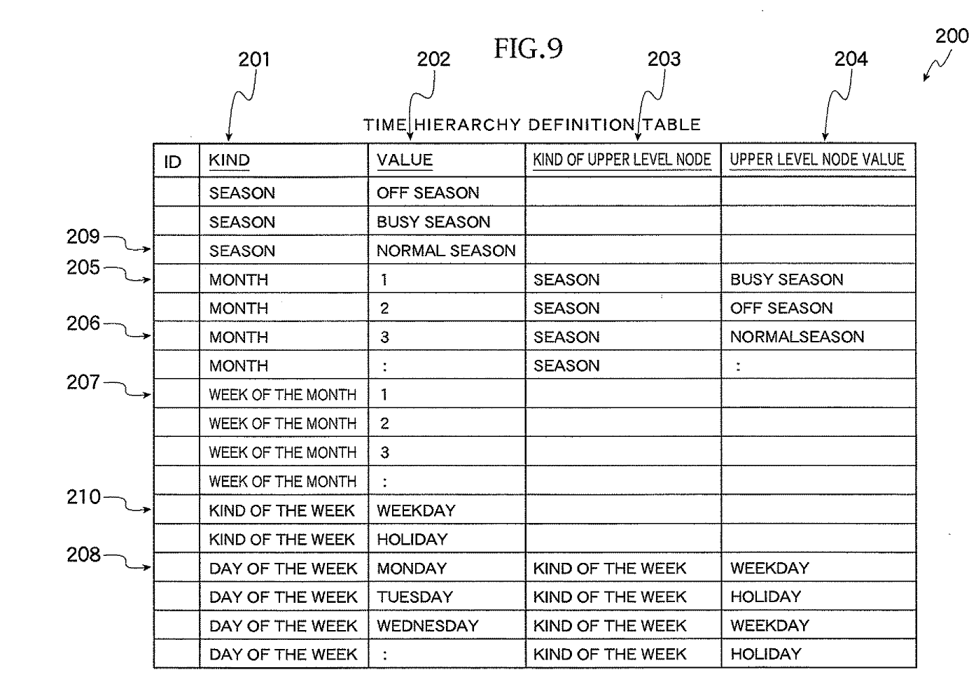

FIG. 9 is a schematic diagram showing the time hierarchy definition table which is controlled at the time-data hierarchical-control section of the scheduling chart creation system 1 of this embodiment.

This time hierarchy definition table 200 is made from the time hierarchy shown in FIG. 8. Each node and relationship between the nodes are defined by a kind column 201, a value column 202, an upper-level-node kind column 203, an upper-level-node value column 204, and each line represents one node. For example, 205 of line 4 shows that the “month hierarchy” is “January” node, the upper hierarchy is “Season hierarchy” and the “upper node” thereof is a “busy season” node (FIG. 8).

The time-data hierarchical-control section 6221c2 of this embodiment is provided with a time-rule table (not shown). In this time-rule table, a table data having various rule information shown (A) below is formed.

{date requirement}−{staff requirement}−{rule body}−{limit value} (A)

wherein in (A), “{ }” represents a unit of information, “-” represents a correlation between the units of information, In {date requirement}, a specific node of time hierarchy is defined (kind column 201 in FIG. 9). In {staff requirement}, a position etc. of staff is defined (a node of the role hierarchy in FIG. 4). In {rule body}, an objective function and an equation of the constraint conditions (equations (1)-(5) mentioned above) are defined. In {limit value}, a specific limit value such as the number of employees and working hours are defined. As a result, time-series working conditions such as “in a busy season, more than 15 employees of sales hierarchy are scheduled to work” is defined.

Next, procedure for extracting a rule using these tables will be explained.

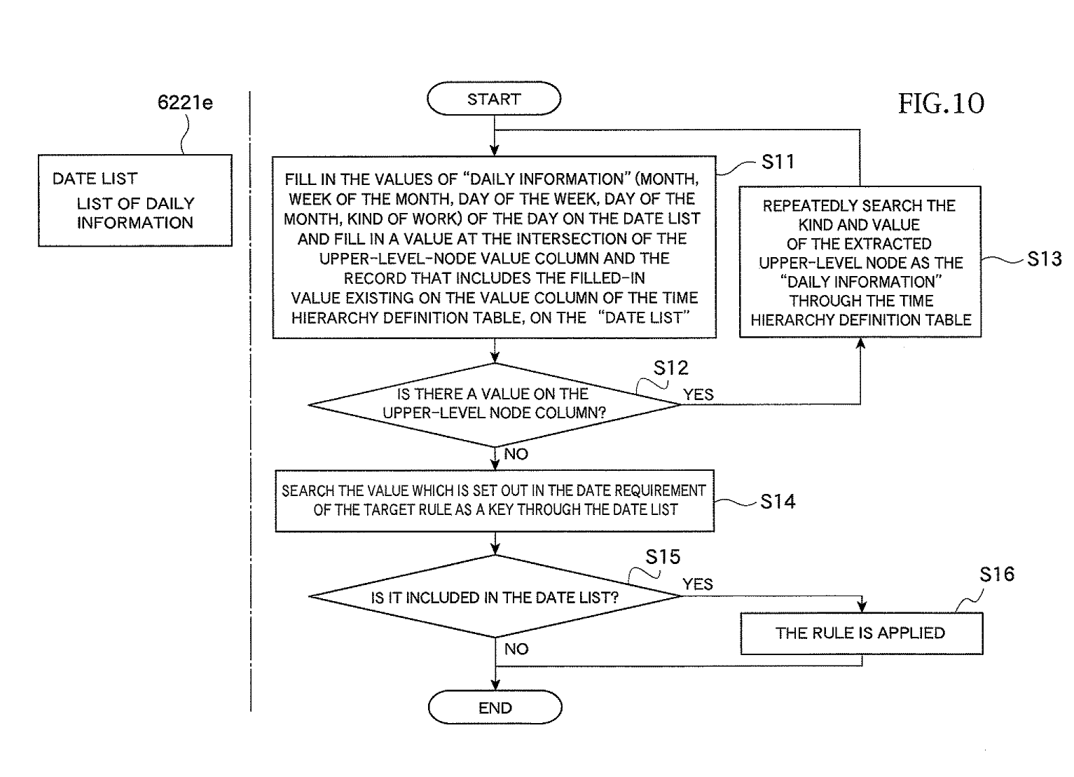

FIG. 10 is a flowchart showing a processing of extraction of a rule information which is applied to a specific time using each table which is controlled at the time-data hierarchical-control section 6221c2 of the scheduling chart creation system 1 of this embodiment. This processing is performed at the application selection section 6221d. This flowchart illustrates an example of the extraction process of the rule information which is applied to a specific “date”. Processing for any time (for example, any hierarchy such as “season”, “time” etc. in FIG. 8) other than “date” can be performed similarly using similar procedure shown in FIG. 10. In a case where a rule information which is applied to “March 1^{st}, Monday” is extracted, the application selection section 6221d extracts a line on which a relevant kind of time is described on the value column 202 of the time hierarchy definition table 200. The extracted line information is stored in “date list (refer to 6221e in FIG. 10, practically as shown in FIG. 2 the “date list” is formed at a portion of application selection section 5221d) (step S11). For example, in the time hierarchy definition table 200 of FIG. 9, the line 206 of “March (month)” of the value column 202, the line 207 of “1 (week of the month)” of the value column 202 and the line 208 of “Monday (day of the week)” of the value column 202 are extracted and stored on the “date list”. If values in the upper-level-node kind column 203 of the extracted line and in the upper level node value column 204 of the extracted line (“Yes” in Step S12) exist, searching and extraction of lines containing said values in the kind column 201 and the value column 202 are performed (Step S13). In the time hierarchy definition table 200 of FIG. 9, the line 209 of “ordinary season” of value column 202 and line 210 of “weekday” of value column 202 are extracted. Specifically, the Steps S12 to S13 performs extraction using time hierarchy definition table 200 in such a manner that the process tracks back from each model extracted at the step S11 to the uppermost node along each node tree (FIG. 8).

After the completion of the step S13 (“No” at Step S12), the application selection section 6221d extracts the information stored on the date list (Step S14), and extracts a relevant rule from the time-rule table (not shown) (“Yes” at Step S15) and applies the rule (Step S16) If no rule can be extracted from the time-rule table (“No” at Step S15), rule application is not performed.

As mentioned above, the time-data hierarchical-control section 6221c2 has information related to the working pattern such as working day, with or without shift, non-working day etc. as a rule information, and hierarchically manages the information on the working pattern. A plurality of information which are relevant to each other can hierarchically be controlled based on a time information which directly relates to the type of work and work volume and can integrally be utilized.

As stated above, an increase in the rule information induced by the difference in the type of work and work volume arising from the season, month, day etc. can reasonably be controlled, and the convenience in handling the rule information at the time of creating the schedule information can be enhanced.

As the result of implementation of the procedure shown in FIGS. 7 and 10, the integer programming solver 6222 creates a scheduling chart using the objective function and constraint conditions, which constitute the rule information based on the organization and time data, and a parameter necessary for calculation. Accordingly, a scheduling chart highly applicable to the organization and the time to be applied can be easily created by computer.

### Second Embodiment

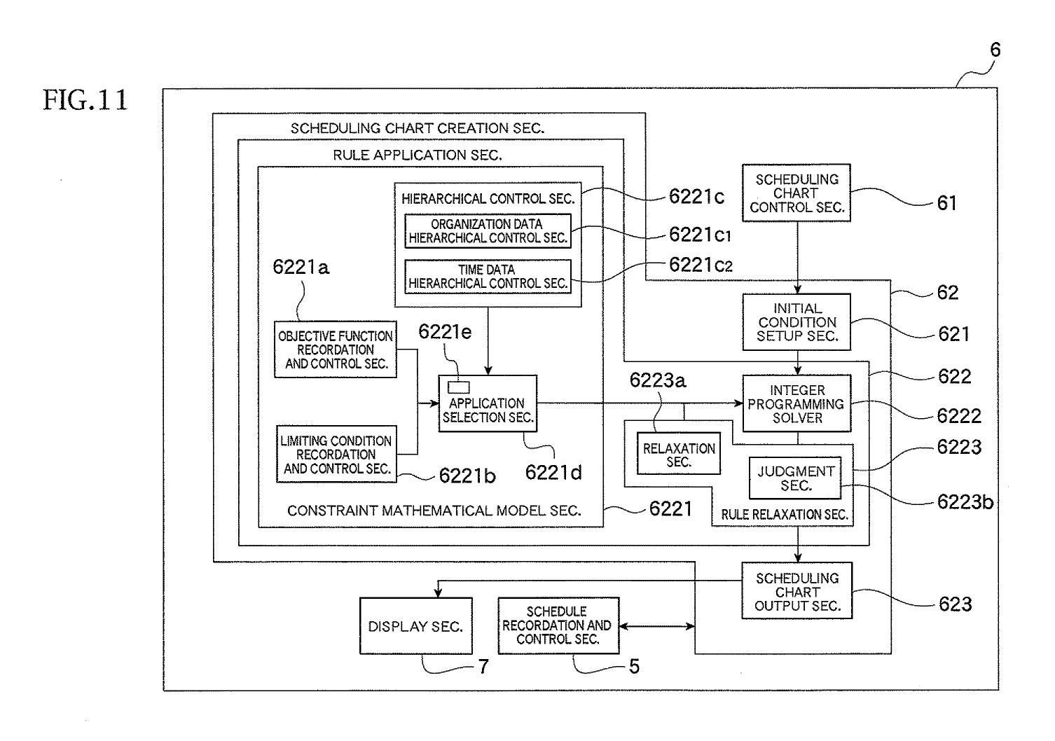

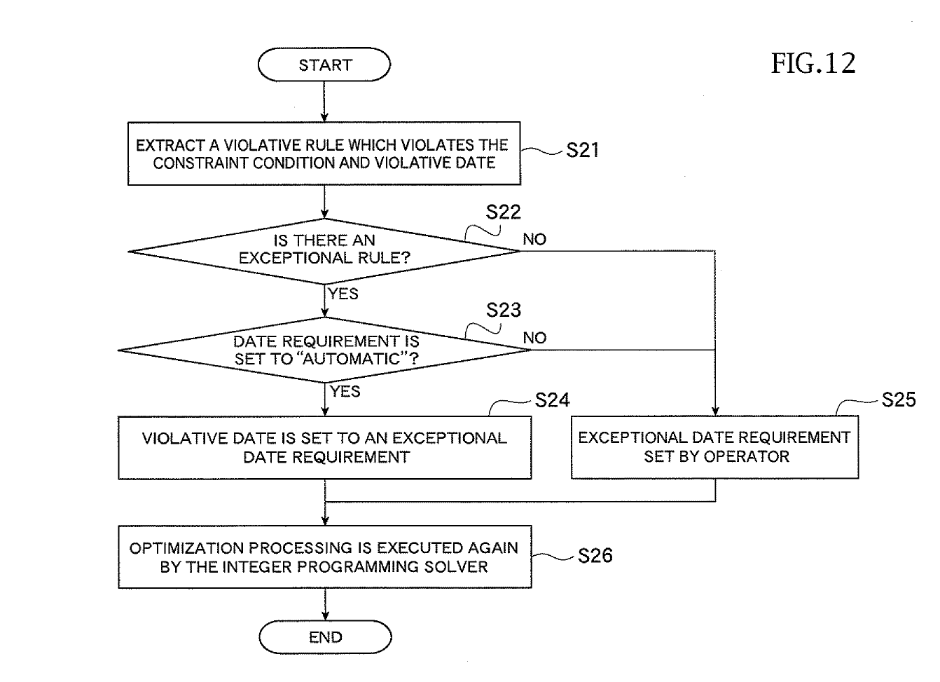

A second embodiment of the present invention will be explained with reference to FIGS. 11 and 12.

FIG. 11 is a functional block diagram of a scheduling chart creation system 1 of the second embodiment. As shown in FIG. 11, an optimum processing section 6 of the scheduling chart creation system 1 of this embodiment is provided with a rule relaxation section G223. When the scheduling chart cannot be created at a solver G222 using the rule information selected by the application selection section 6221d, the rule relaxation section 6223 relaxes a rule information so that the scheduling chart can be created in the integer programming solver. The rule relaxation section 6223 is comprised of a judging section 6223b which decides whether or not the scheduling chart can be created using the rule information, and a relaxation section 6223a which performs the relaxation of the rule information when the judging section 6223b finds that the scheduling chart can not be created.

In the time-data hierarchical control section 6221c2, a time-rule table (not shown) is provided. The time-rule table has various exceptional rule information shown below (B) in addition to the rule information (A) in the embodiment 1 mentioned above. The exceptional rule information (B) is correlated with a specific rule information and forms information to be exceptionally applied at the time the specific rule information can not be applied.

{date requirement}−{staff requirement}−{limit value} (B)

wherein in (B)
“{ }”: unit of information
“-”: symbol showing relationship between the units of information
A specific node of the time hierarchy is defined for the {date requirement} (refer to kind column 201 in FIG. 9). A position etc. of staff is defined for the {staff requirement} (refer to node etc. of the role hierarchy in FIG. 4).

A concrete limit value of the number and working time etc. of employee is defined for {limit value}.

As a whole, for example, “(in a case where a general rule such as “more than 10 employees should be scheduled to work on Sunday”, which is provided by a rule information (A), can not be applied or accepted), working conditions such as 6 to 9 employees can be scheduled to work instead” is defined instead.

On the time rule table (not shown) of this embodiment, an automatically changeable yes-or-no information is also recorded, which determines whether {the date requirement} of the rule information (A) and the exceptional rule information (B) can be changed automatically or not.

Other configurations are the same as the first embodiment.

FIG. 12 is a flowchart showing a relaxation procedure of the rule information of the scheduling chart creation system 1 of this embodiment. A concrete procedure will be explained with reference to FIG. 12.

After the procedure shown in FIGS. 7 and 10, rule information based on the organization data and time data are applied to the integer programming solver 6222. As a result of the above application, when the judging section 6223b of the rule relaxation section 6223 finds that a scheduling chart based on the constraint conditions can not be created, the judging section 6223b extracts violative rule which offends against the constraint and the violative date (Step S21). For example, although there is a rule information saying “more than 10 employees should be scheduled to work on Sunday”, there is also another information in a calendar control section 61 and the schedule recordation-and-control section 5 saying only 9 employees can be scheduled to work due to holiday or business trip on a particular Sunday.

In such case, the “violative rule” and “violative date” corresponds to the condition to be extracted. Next, the judging section 6223b confirms whether exceptional rule information (above mentioned (B)) exists or not with reference to, for example, the time rule table (not shown).

If the existence of the exceptional rule information is confirmed (“Yes” at Step S22) and if the automatically yes-or-no changeable information of {date requirement} of the exceptional rule information (B) and the rule information (A) which is associated with the exceptional rule information (B), is set to “automatic changeable condition” (“Yes” at Step S23), the relaxation section 6223a changes the “violative date” to an exceptional day condition and also carries out a setting in which “violative date” is stored on an exceptional “date list (6221e in FIGS. 10 and 11) (Step S24)”, and the optimum processing by the integer programming solver 6223 is performed again (Step S26).

However, in the case mentioned above, if the exceptional rule information (B) does not exist (“No” at Step S22) or if the automatically yes-or-no changeable information of {day requirement} is set to no “automatic changeable condition” (“No at Step S23), the operator of the scheduling chart creation system 1 manually changes the setting into “exceptional” (Step S25). According to such setting, the processing of the Step S26 is performed.

That is, in this embodiment, the rule relaxation section 6223 is provided for relaxing the rule information so that the rule information can be applied to the scheduling chart. Therefore, when the integer programming solver 6222 can not create a scheduling chart using the rule information selected by the application selection section 6221d, the rule relaxation section 6223 adjusts the application conditions of the rule information, in response to the changing status, being able to prevent undesirable situation where the scheduling chart can not be created because the constraint condition are not met.

As mentioned above, the scheduling chart creation system of the present invention has the hierarchical control section 6221c and the application selection section 6221d. The hierarchical control section 6221c manages various rule information in the form of a hierarchical structure. The rule information is an information of employment conditions and forms a constraint condition at the time of creating the scheduling chart.

The application selection section 6221d selects the rule information, which is applied in creating the scheduling chart, from the rule information hierarchically controlled by the hierarchical control section 6221c.

Accordingly, various rule information which are highly relevant to each other can be controlled as one group and can also be used for creating the scheduling chart. A plurality of constraint conditions, which are used at the time of creating the scheduling chart, are reasonably controlled and the scheduling chart which can be applied to various working patterns and employment conditions can be created without imposing excessive burden on the computer.

In the embodiments mentioned above, each functional means is formed based on a result obtained by a computation of a program etc. To improve the processing speed, all or a portion of the functional means may be composed of a hardware logic.

The embodiments mentioned above are only typical examples, and the present invention is not limited to these embodiments. The present invention can be embodied in other specific forms without departing from the essential features thereof.

1. A scheduling chart creation system for automatically creating a date and time scheduling chart for an employee of a company, which comprises:
hierarchical control means for controlling various rule information in the form of a hierarchical structure, the rule information being obtained from information on employment conditions of the employee and forming a constraint condition used at the time of creating the scheduling chart; and
an application selection means for selecting the rule information which is applied to the creating of the scheduling chart from the various rule information which is hierarchically controlled by the hierarchical control means.

2. A scheduling chart creation system according to claim 1, wherein the hierarchical control means comprises an organization-data hierarchical control means in which organization-related information of a department etc. to which the employee belongs is held as the rule information and the organization-related information is hierarchically controlled.

3. A scheduling chart creation system according to claim 1, wherein the hierarchical control means comprises a working-time data hierarchical control means in which working pattern-related information including such as a working day, with or without shift, non-working day etc. of the employee is stored as the rule information and the working pattern-related information is hierarchically controlled.

4. A scheduling chart creation system according to claim 1, wherein the scheduling chart creation system has an integer programming solver which creates the scheduling chart through an integer programming using an objective function and a prescribed constraint condition, the application selection means selects the rule information having both the objective function capable to be applied to the integer programming solver and the prescribed constraint condition capable to be applied to the integer programming solver, and the integer programming solver creates the scheduling chart using the rule information selected by the application selection means.

5. A scheduling chart creation system according to claim 4, wherein the scheduling chart creation system has a rule-relaxation means, when the integer programming solver does not create the scheduling chart using the rule information selected by the application selection means, the rule-relaxation means being designed to relax the rule information so that scheduling chart can be created in the integer programming solver.

6. A program for making a computer function as the scheduling chart creation system according to claim 1.
